(19) United States
(12) Patent Application Publication
(10) Pub. No.: US 2009/0028630 A1
(43) Pub. Date: Jan. 29, 2009

(54) SHAFT/HUB CONNECTION AND MANUALLY GUIDED IMPLEMENT

(76) Inventors: Ralf-Rainer Kemmler, Schwaikheim (DE); Eberhard Bohnaker, Leutenbach (DE)

Correspondence Address: ROBERT W. BECKER & ASSOCIATES, 707 HIGHWAY 333, SUITE B, TIJERAS, NM, 87059-7507, US

(21) Appl. No.: 12/177,397

(22) Filed: Jul. 22, 2008

(30) Foreign Application Priority Data
Jul. 27, 2007 (DE) 10 2007 035 337.7

(51) Int. Cl. F16D 1/06

(52) U.S. Cl. 403/1

(57) ABSTRACT

A shaft/hub connection between a shaft rotatably driven about an axis of rotation, and a hub disposed on the shaft so as to be non-rotatable relative thereto. A conical shaft extension on the shaft extends into a conical opening of the hub and is held in the hub via a conical pressure connection. The hub is provided with a stress-relieving or antifatigue arrangement for reducing the dynamic fatigue stresses that occur on the hub during operation. The shaft/hub connection is advantageously utilized for connecting the crankshaft of the internal combustion engine of a manually guided implement with a flywheel.

The instant application should be granted the priority date of Jul. 27, 2007 the filing date of the corresponding German patent application DE 10 2007 035 37.7.

### BACKGROUND OF THE INVENTION

The present invention relates to a shaft/hub connection between a shaft that is rotatably driven about an axis of rotation, and a hub component that is disposed on the shaft so as to be non-rotatable relative thereto. The present invention also relates to a manually guided implement having an internal combustion engine with a flywheel secured in position on a crankshaft that is rotatably driven by the engine.

With manually guided implements, such as power saws, cut-off machines, or the like, it is known to dispose a flywheel on the crankshaft via a conical pressure connection. During operation, high dynamic stresses are superimposed over the static base load of the flywheel hub. This can lead to a shortening of the service life of the flywheel.

It is an object of the present application to provide a shaft/hub connection of the aforementioned general type that has a long service life. It is a further object of the present invention to provide a manually-guided implement, the flywheel of which has a long service life.

### BRIEF DESCRIPTION OF THE DRAWINGS

These and other objects and advantages of the present application will appear more clearly from the following specification in conjunction with the accompanying schematic drawings, in which:

FIG. 1 shows a side view of a power saw;

FIG. 2 is a sectional view through the power saw of FIG. 1;

FIG. 3 is a perspective illustration of the crankshaft of the power saw of FIG. 1 with a clutch and a flywheel disposed thereon;

FIGS. 4 and 5 are cross-sectional views of embodiments of the flywheel hub; and

FIG. 6 is a perspective cross-sectional illustration of the flywheel hub of FIG. 5.

### SUMMARY OF THE INVENTION

The present application provides a shaft/hub connection that comprises a shaft adapted to be rotatably driven about an axis of rotation; a hub disposed on the shaft so as to be non-rotatable relative thereto; a conical shaft extension provided on the shaft, wherein the shaft extension extends into a conical opening of the hub and is held in the hub via a conical pressure connection; and stress-relieving or antifatigue means disposed on the hub for reducing dynamic fatigue stresses that occur on the hub during operation.

It has been shown that the static stresses can be reduced by a massive or bulky design of the hub. In this connection, however, the stresses that occur during the dynamic operation simultaneously increase. A massive design of the hub does not necessarily lead to a longer service life. It has been shown that the service life is lengthened if stress-relieving or antifatigue means are provided that reduce the dynamic fatigue stresses that occur during operation. As a result, with a hub having adequate static strength the dynamic stresses can also be reduced, resulting on the whole in a longer service life.

The antifatigue means, as viewed in the direction of the axis of rotation, are advantageously provided approximately at the level of the maximum inner diameter of the hub. The greatest dynamic fatigue stresses occur in this region.

To reduce the dynamic fatigue stresses, the hub can be extended beyond the conical shaft extension on that side that has the maximum inner diameter, thereby forming an extension. In this connection, the opening of the hub advantageously also extends conically in the region of the hub extension. A conical annular gap thus results between the extension of the hub and the shaft. In the extending region, no forces are introduced into the hub, so that this region serves for reinforcement. Consequently, the dynamic stresses can be reduced. The extension advantageously has an axial length that corresponds to approximately 10% to approximately 50% of the greatest diameter of the shaft extension. The axial length of the extension is advantageously more than 20% of the greatest diameter of the shaft extension.

To reduce the dynamic fatigue stresses, the hub can also be provided with at least one relief groove. The relief groove reduces the rigidity of the hub in the region of the greatest inner diameter. Consequently, the dynamic fatigue stresses can be reduced. Due to the fact that radially beyond the relief groove an edge of the hub remains, it is possible at the same time to keep the static fatigue stress adequately low. The relief groove advantageously extends into the hub component from the end face of the hub that has the greatest inner diameter. The relief groove expediently extends approximately or exactly parallel to the axis of rotation of the shaft. This results in favorable stress gradients. However, the relief groove can also extend parallel to the axis of rotation of the shaft. In this connection, the relief groove advantageously extends about the opening in a circular arc-shaped manner at least at one portion of the periphery of the opening. A plurality of relief grooves that are embodied as circular sectors can be provided. A uniform relief of stress can be achieved if the relief groove extends over the entire periphery of the opening.

The relief groove advantageously has a depth, extending parallel to the axis of rotation, that corresponds to approximately 5% to approximately 25% of the greatest diameter of the shaft extension. In the radial direction, the relief groove advantageously has a width that corresponds to approximately 3% to approximately 20% of the greatest diameter of the shaft extension.

The length of the hub, measured in the direction of the axis of rotation, advantageously corresponds to approximately one half to approximately twice the maximum outer diameter of the hub in the region of the stress-relieving or antifatigue means. This enables an adequate strength of the hub.

In particular when providing an extension on the hub, a reduction of the outer diameter of the hub is provided. The maximum outer diameter of the hub in the region of the stress-relieving or antifatigue means expediently corresponds to less than approximately 190%, and especially less than approximately 175%, of the greatest diameter of the shaft extension. The outer diameter of the hub is reduced in comparison to known hub configurations. Consequently, the dynamic fatigue stresses that occur can be kept low. In this connection, the diameter of the hub in the region of the stress-relieving or antifatigue means, especially in the region of the extension, can decrease. In this connection, for example, a rounded-off or conical course of the outer diameter can be provided. The minimum outer diameter of the hub in the region of the stress-relieving or antifatigue means is advantageously less than approximately 175%, especially less than approximately 150%, of the greatest diameter of the shaft extension. The axial length of the shaft extension is expediently approximately 70% to approximately 150% of the greatest diameter of the shaft extension. To achieve a reliable connection of shaft and hub, the connection can be provided with means for a positive or interlocking securement of the position of rotation of hub and shaft relative to one another. The means for the positive securement can, for example, include an adjusting spring. Other means for the positive securement can also be advantageous.

For a manually guided implement having an internal combustion engine that rotatably drives a crankshaft, wherein a flywheel is secured in position on the crankshaft, the hub of the flywheel can be provided with stress-relieving or antifatigue means for reducing the dynamic fatigue stresses that occur on the flywheel hub during operation. As a result, the service life of the hub is lengthened. At the same time, the weight of the flywheel hub can be kept relatively low, resulting in a low overall weight of the manually guided implement.

Further specific features of the present invention will be described in detail subsequently.

### Description of Specific Embodiments

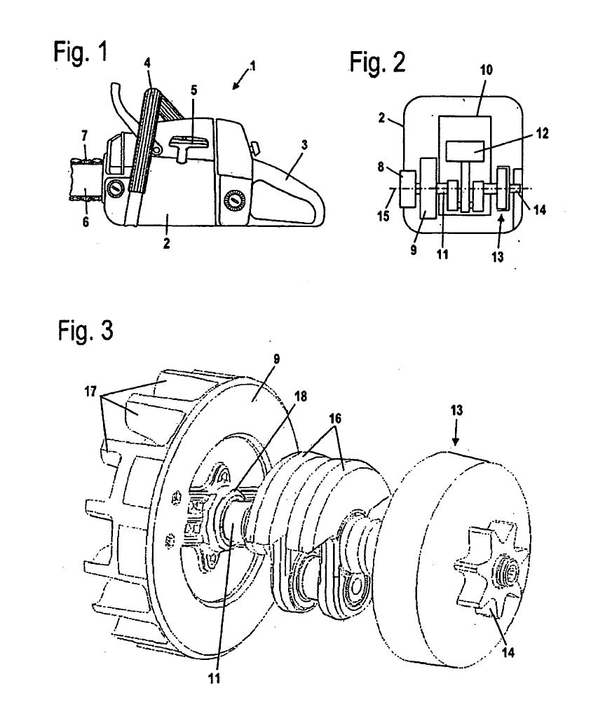

Referring now to the drawings in detail, the power saw 1, which is schematically shown in FIG. 1, has a housing 2 on which are secured a rear handle 3 and a tubular handle 4 for guiding the power saw 1. Extending from the housing 2 is a starter handle 5 for starting the drive motor of the power saw 1. Disposed on the power saw 1 is a guide bar 6 on which a saw chain 7 is driven in a circulating manner.

The saw chain 7 is driven by the driving pinion 14, which is shown in FIG. 2. The pinion 14 is connected via a centrifugal clutch 13 with a crankshaft 11 of an internal combustion engine 10 that is disposed in the housing 2. The internal combustion engine 10 is, in particular, a two-cycle engine or a mixture-lubricated four-cycle engine. The crankshaft 11 is driven in a rotating manner about an axis of rotation 15 by a piston 12 of the internal combustion engine 10.

On that side of the internal combustion engine 10 opposite the driving pinion 14 a flywheel 9 is secured to the crankshaft 11. Provided adjacent to the flywheel 9 is a starter device 8 that is actuated by the starter handle 5 and via which the crankshaft 11 can be set to rotate for starting the internal combustion engine 10.

As shown in the perspective illustration of FIG. 3, the crankshaft 11 has two crank webs 16. The flywheel 9 has a hub 18, via which the flywheel is secured to the crankshaft 11. The flywheel 9 is at the same time embodied as a fan wheel and has a plurality of vanes 17 for conveying cooling air.

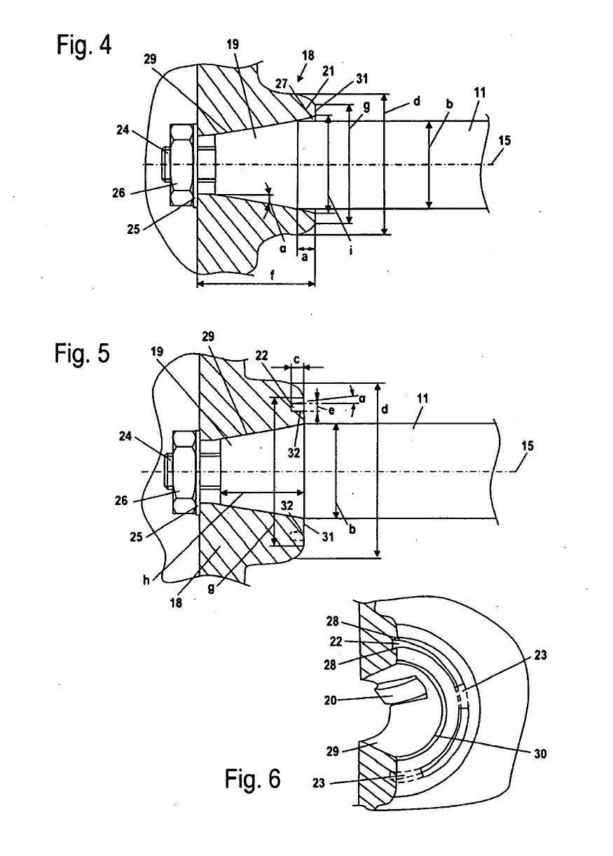

FIG. 4 shows the configuration of the hub 18 and of the crankshaft 11 in the vicinity of the hub 18. The crankshaft 11 has a shaft extension 19 that tapers out conically and on the end of which is disposed a threaded lug 24. The hub 18 has a conical opening 29 into which the shaft extension 19 extends. The cone angle a of the conical opening 29 corresponds to the cone angle a of the shaft extension 19. A washer 25 and a nut 26 are disposed on the threaded lug 24. The nut 26 is threaded onto the threaded lug 24 and via the washer 25 presses the hub 18 onto the shaft extension 19, so that the flywheel 9 is held on the shaft extension 19 via a conical pressure connection.

On that side facing away from the nut 26 the hub 18 has an extension 21. The extension 21 is thus disposed on that side of the hub 18 toward which the conical opening 29 widens. The extension 21 is disposed in the region of the greatest inner diameter i of the hub 18. The opening 29 also extends conically in the region of the extension 21. In the region of the extension 21, the crankshaft 11 is cylindrical, so that an annular gap 27 is formed between the crankshaft 11 and the extension 21 of the hub 18. The extension 21 has an axial length a, measured parallel to the axis of rotation 15, that is approximately 10% to approximately 50% of the greatest diameter b of the shaft extension 19. The greatest diameter b of the shaft extension 19 corresponds to the diameter of the crankshaft 11. The axial length a is advantageously at least approximately 20% of the greatest diameter b of the shaft extension 19.

In the region of the extension 21, the outer diameter of the hub 18 decreases toward an end face 31 of the hub 18. The end face 31 is that end face of the hub 18 that faces the crankshaft 11 and the internal combustion engine 10. In this connection, the outer surface of the hub 18 extends in a curved manner. However, this outer surface can also be provided with a conical path. The extension 21 has a maximum diameter d that is less than approximately 190%, and in particular less than approximately 175%, of the greatest diameter b of the shaft extension 19. Thus, the maximum outer diameter d is less than that of known hub configurations that have no extension 21. The minimum outer diameter g of the extension 21, which in the embodiment illustrated in FIG. 4 is disposed at the end face 31, is advantageously less than approximately 175%, and in particular less than approximately 150%, of the greatest diameter b of the shaft extension 19. The hub 18 has an overall length f, measured in the direction of the axis of rotation 15, that corresponds to about half to about twice the maximum outer diameter d of the hub 18 in the region of the extension 21. In this connection, the extension 21 extends from the greatest diameter b of the shaft extension 19, in other words from the region at which the shaft extension 19 merges into the crankshaft 11, to the end face 31.

FIG. 5 shows a further embodiment of the configuration of the hub 18. With this embodiment, the end face 31 is provided with a relief groove or slot 22 which, as also shown in FIG. 6, is composed of four circular sectors that are separated from one another by ribs or similar elements 23. As indicated by dashed lines in FIGS. 5 and 6, the relief groove 22 can, however, also extend as a circular ring-shaped groove along the entire periphery of the opening 29. The relief groove 22 has a depth c, as measured parallel to the axis of rotation 15, that corresponds to approximately 5% to approximately 25% of the greatest diameter b of the shaft extension 19. The relief groove 22 has a width e, as measured in a radial direction relative to the axis of rotation 15, that corresponds to approximately 3% to approximately 20% of the greatest diameter b of the shaft extension 19. In the embodiment illustrated in FIG. 5, the shaft extension 19 ends at the end face 31 of the hub 18. However, it is also possible, in addition to the relief groove 22, that an extension 21 be provided on the hub 18.

As shown in FIG. 5, the groove 22 extends parallel to the axis of rotation 15, so that the inwardly disposed side wall and the outwardly disposed side wall extend essentially parallel to the axis of rotation 15, The walls 28 (FIG. 6) may be respectively inclined in an opposite direction relative to the axis of rotation 15 by only a slight mold release angle α of approximately 2°. In this connection, the side walls 28 shown in FIG. 6, in other words the radially inwardly disposed and the radially outwardly disposed walls of the relief groove 22, extend angled to each other. As shown by the dashed line 32 in FIG. 5, only the radially inwardly disposed wall of the relief groove 22 can extend in the opposite direction relative to the radially outwardly disposed wall of the relief groove 22. In this connection, the angle of inclination a can be small and is selected such that during manufacture in a casting process, the hub 18 can be released or removed from the mold in the direction of the axis of rotation 15. The radially outwardly disposed wall of the relief groove 22 also advantageously extends at an angle that corresponds at least to a mold removal angle. As shown in dashed lines in FIG. 5, the relief groove 22 respectively widens toward the end face 31 due to the opposite inclination of the side walls, which extend in the circumferential direction.

The maximum outer diameter d in the region of the relief groove 22 is measured at the level of the base of the relief groove 22. The minimum outer diameter g is also measured at the end face 31 in the embodiment of FIG. 5. In the region of the relief groove 22, the hub 18 extends in a curved manner from the maximum outer diameter d to the minimum outer diameter g.

The axial length h of the shaft extension 19 is less than the axial length f of the hub 18. The axial length of the shaft extension 19 is advantageously approximately 70% to approximately 150% of the greatest diameter b of the shaft extension 19.

As shown in FIG. 6, a bevel 30 is provided on that side of the conical opening 29 that faces the crankshaft 11. Formed on the hub 18 is a radially inwardly extending adjusting spring 20 that projects into a non-illustrated recessed portion on the shaft extension 19 and thus secures the shaft extension 19 in its position of rotation.

The extension 21 and the relief groove 22 serve for the reduction of the dynamic fatigue stresses on the hub 18 at that side that faces the crankshaft 11. It can be advantageous to combine these two stress relieving or antifatigue means with one another. It can also be advantageous to combine them with further antifatigue means or to provide other antifatigue means.

The specification incorporates by reference the disclosure of German priority document DE 10 2007 035 337.7 filed Jul. 27, 2007.

The present invention is, of course, in no way restricted to the specific disclosure of the specification and drawings, but also encompasses any modifications within the scope of the appended claims.

What we claim is:

1. A shaft/hub connection, comprising:
a shaft that is adapted to be rotatably driven about an axis of rotation;
a hub disposed on said shaft so as to be non-rotatable relative to said shaft;
a conical shaft extension provided on said shaft, wherein said shaft extension extends into a conical opening of said hub and is held in said hub via a conical pressure connection; and
stress-relieving or antifatigue means disposed on said hub for reducing dynamic fatigue stresses that occur on said hub during operation.

2. A shaft/hub connection according to claim 1, wherein said stress-relieving or antifatigue means, as viewed in the direction of said axis of rotation, is provided approximately at the level of a greatest inner diameter of said hub.

3. A shaft/hub connection according to claim 1, wherein on a side having a greatest inner diameter, said hub is extended beyond said conical shaft extension to form an extension.

4. A shaft/hub connection according to claim 3, wherein said conical opening of said hub also extends conically in the region of said extension of said hub.

5. A shaft/hub connection according to claim 4, wherein a conical annular gap is formed between said extension of said hub and said shaft.

6. A shaft/hub connection according to claim 3, wherein said extension of said hub has an axial length that corresponds to approximately 10% to approximately 50% of a greatest diameter of said shaft extension.

7. A shaft/hub connection according to claim 1, wherein said hub is provided with at least one relief groove.

8. A shaft/hub connection according to claim 7, wherein said relief groove extends into said hub from an end face of said hub having the greatest inner diameter.

9. A shaft/hub connection according to claim 7, wherein said relief groove extends approximately parallel to the axis of rotation of said hub.

10. A shaft/hub connection according to claim 7, wherein said relief groove extends about said conical opening of said hub in a circular arc-shaped manner at least along a portion of the periphery of said opening.

11. A shaft/hub connection according to claim 10, wherein said relief groove extends over the entire periphery of said conical opening.

12. A shaft/hub connection according to claim 7, wherein said relief groove has a depth, as measured parallel to said axis of rotation, that corresponds to approximately 5% to approximately 25% of a greatest diameter of said shaft extension.

13. A shaft/hub connection according to claim 7, wherein said relief groove has a width, as measured in a radial direction relative to said axis of rotation of said shaft, that corresponds to approximately 3% to approximately 20% of a greatest diameter of said shaft extension.

14. A shaft/hub connection according to claim 1, wherein a length of said hub, as measured in the direction of said axis of rotation, corresponds to approximately one half to approximately twice the maximum outer diameter of said hub in the region of said stress-relieving or antifatigue means.

15. A shaft/hub connection according to claim 1, wherein the maximum outer diameter of said hub in the region of said stress-relieving or antifatigue means corresponds to less than approximately 190% of a greatest diameter of said shaft extension.

16. A shaft/hub connection according to claim 15, wherein the maximum outer diameter of said hub in the region of said stress-relieving or antifatigue means corresponds to less than approximately 175% of the greatest diameter of said shaft extension.

17. A shaft/hub connection according to claim 1, wherein the minimum outer diameter of said hub in the region of said stress-relieving or antifatigue means corresponds to less than approximately 175% of a greatest diameter of said shaft extension.

18. A shaft/hub connection according to claim 17, wherein the minimum outer diameter of said hub in the region of said stress-relieving or antifatigue means corresponds to less than approximately 150% of the greatest diameter of said shaft extension.

19. A shaft/hub connection according to claim 1, wherein the connection is provided with means for a positive or interlocking securement of a position of rotation of said hub and said shaft relative to one another.

20. A manually guided implement having an internal combustion engine, comprising:
a crankshaft that is adapted to be rotatably driven by the internal combustion engine;
a flywheel having a hub that is secured in position on said crankshaft; and
stress-relieving or antifatigue means disposed on said hub for reducing dynamic fatigue stresses that occur on said hub during operation.
